(19) United States
(12) Patent Application Publication
(10) Pub. No.: US 2026/0305655 A1
(43) Pub. Date: Oct. 8, 2026

(54) COMPOSITIONS FOR REDUCING OFF NOTES AND USES THEREOF

(71) Applicant: DSM-FIRMENICH AG, Kaiseraugst (CH)

(72) Inventor: Ronald Skiff, Plainsboro, NJ (US)

(21) Appl. No.: 19/490,281

(22) PCT Filed: Jun. 5, 2024
(86) PCT No.: PCT/EP2024/065376

§ 371 Date: Dec. 4, 2025

Related U.S. Application Data
(60) Provisional application No. 63/507,216, filed on Jun. 9, 2023.

(30) Foreign Application Priority Data
Aug. 7, 2023 (EP) 23189940.2

(51) Int. Cl. A23L 2/56; A23L 2/60; A23L 27/20

(52) U.S. Cl. CPC A23L 2/56; A23L 2/60; A23L 27/204; A23L 27/2052

(57) ABSTRACT

The present disclosure generally provides flavor-modifying compositions that reduce certain off notes, such as astringent or bitter tastes, from vitamin or mineral compounds. In some aspects, the disclosure provides uses of such flavor-modifying compositions to reduce an off note of a vitamin or mineral compound in a flavored product, such as a food or beverage product or an oral care product. In some other aspects, the disclosure provides flavored products (such as food or beverage products or oral care products), which comprise a vitamin or mineral compound and a flavor-modifying composition of the present disclosure.

### TECHNICAL FIELD

The present disclosure generally provides flavor-modifying compositions that reduce certain off notes, such as astringent or bitter tastes, from vitamin or mineral compounds. In some aspects, the disclosure provides uses of such flavor-modifying compositions to reduce an off note of a vitamin or mineral compound in a flavored product, such as a food or beverage product or an oral care product. In some other aspects, the disclosure provides flavored products (such as food or beverage products or oral care products), which comprise a vitamin or mineral compound and a flavor-modifying composition of the present disclosure.

### DESCRIPTION OF RELATED ART

The sensing of flavor is an important component of the organoleptic properties of food and beverage products. The taste system is a key component of the sensing of flavor. The taste system provides sensory information about the chemical composition of the external world. Taste transduction is one of the more sophisticated forms of chemically triggered sensation in animals. Signaling of taste is found throughout the animal kingdom, from simple metazoans to the most complex of vertebrates. Mammals are believed to have five basic taste modalities: sweet, bitter, sour, salty, and umami. In addition to taste, the sensing of flavor can involve a number of other features, such as heating, cooling, mouthfeel, mouthcoating, astringency, juiciness, chalkiness, thickness, and kokumi effects commonly associated with fermented products.

Foods and beverages designed to support wellness, athletic performance, or workout recovery have become common in recent years. Many such food and beverage products include various vitamins, minerals, antioxidants, electrolytes, and other such ingredients to improve the health and wellness benefits of the product. But many of these ingredients impart certain undesirable flavor properties to the product, such as bitter notes, astringent notes, metallic notes, lingering aftertastes, and the like. The prominence of such off notes can sometimes be mitigated by making the food or beverage sweeter. But this requires either increasing the caloric content of the beverage by introducing nutritive sweeteners or creating a cloying over-sweetness by using a higher concentration of high-intensity non-nutritive sweeteners. Neither solution is ideal. It would be beneficial to develop a more tailored solution to providing selective reduction of one or more of the relevant off notes.

Therefore, there is a need to develop new compositions that can effectively reduce the perception of certain off notes, such as bitter notes, astringent notes, metallic notes, and the like, in food and beverage products that contain some combination of vitamins, minerals, antioxidants, and electrolytes.

### SUMMARY

The present disclosure relates to the discovery that certain compositions exhibit an unexpected effectiveness at reducing the perception of off notes caused by the presence of mineral compounds (such as sodium, calcium, potassium, and magnesium compounds), vitamins, or other health-promoting ingredients in food, beverage, or oral care products.

In a first aspect, the disclosure provides a flavor-modifying composition, the composition comprising: (a) a vanillic flavor compound; (b) optionally, a furanone compound; (c) optionally, a flavonoid, a dihydrochalcone, or a combination thereof; and (d) optionally, a sweetener. In some embodiments, the flavor modifying composition comprises a furanone compound. In some embodiments, the flavor-modifying composition comprises a flavonoid, a dihydrochalcone, or a combination thereof. In some embodiments, the flavor-modifying composition comprises a sweetener.

In a second aspect, the disclosure provides uses of the flavor-modifying composition of the first aspect to reduce an off note of a flavored product. In some embodiments, the off note is a bitter taste, an astringent taste, a metallic taste, a sour taste, a salty taste, a burning taste, an aldehydic taste, or any combination thereof. In some embodiments, the flavored product is a food product or a beverage product, such as a protein bar, a meal-replacement shake, or a workout recovery drink. In some other embodiments, the flavored product is an oral care product, such as a toothpaste, a mouthwash, or a tooth-whitening composition.

In a third aspect, the disclosure provides methods for reducing an off note of a flavored product, the method comprising introducing a flavor-modifying composition of the first aspect to the flavored product. In some embodiments, the off note is a bitter taste, an astringent taste, a metallic taste, a sour taste, a salty taste, a burning taste, an aldehydic taste, or any combination thereof. In some embodiments, the flavored product is a food product or a beverage product, such as a protein bar, a meal-replacement shake, or a workout recovery drink. In some other embodiments, the flavored product is an oral care product, such as a toothpaste, a mouthwash, or a tooth-whitening composition.

In a fourth aspect, the disclosure provides flavored products comprising a flavor-modifying composition of the first aspect and a health-promoting ingredient, such as a vitamin compound, a mineral compound, an antioxidant, an amino acid, a fatty acid or fatty acid ester, an electrolyte, or any combination thereof. In some embodiments, the health-promoting ingredient has an off note. In some embodiments, the off note is a bitter taste, an astringent taste, a metallic taste, a sour taste, a salty taste, a burning taste, an aldehydic taste, or any combination thereof. In some embodiments, the flavored product is a food product or a beverage product, such as a protein bar, a meal-replacement shake, or a workout recovery drink. In some other embodiments, the flavored product is an oral care product, such as a toothpaste, a mouthwash, or a tooth-whitening composition.

Further aspects, and embodiments thereof, are set forth below in the Detailed Description, the Drawings, the Abstract, and the Claims.

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary

The term “sweetener” or “sweet tastant” refers to a compound that elicits a detectable sweet taste in a subject, e.g., a compound that activates a TIR2/T1R3 receptor in vitro.

The term “bitter tastant” refers to a compound that elicits a detectable bitter taste in a subject, e.g., a compound that activates one or more T2R receptor in vitro.

An “off note” refers to a taste that humans generally perceive as unpleasant, such as a bitter taste, an astringent taste, a metallic taste, a sour taste, a salty taste, a burning taste, an aldehydic taste, or any combination thereof.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation and is not to be limited to an either/or construction. Thus, the phrase “comprising A or B” means that A can be present and not B, or that B is present and not A, or that A and B are both present. Further, if A, for example, defines a class that can have multiple members, e.g., A1 and A2, then one or more members of the class can be present concurrently.

Other terms are defined in other portions of this description, even though not included in this subsection.

### Flavor-Modifying Compositions

In a first aspect, the disclosure provides a flavor-modifying composition, the composition comprising: (a) a vanillic flavor compound; (b) optionally, a furanone compound; (c) optionally, a flavonoid, a dihydrochalcone, or a combination thereof; and (d) optionally, a sweetener. In some embodiments, the flavor modifying composition comprises a furanone compound. In some embodiments, the flavor-modifying composition comprises a flavonoid, a dihydrochalcone, or a combination thereof. In some embodiments, the flavor-modifying composition comprises a sweetener.

Any suitable vanillic flavor compounds can be used, such as any compound capable of imparting a characteristic flavor note associated with phenolic note or vanillic note. Some non-limiting examples include phenol, 2-methoxyphenol, 2-methoxy-4-vinyl-phenol, 4-methyl-phenol, 2-methoxy-4-(2-propen-1-yl)phenol, 2-methoxy-4-(1-propen-1-yl)phenol, 2-methoxy-4-methyl-phenol, 4-ethenylphenol, 2-ethoxy-5-(1-propenyl)phenol, 4-methoxybenzaldehyde, 4-methoxy-benzenemethanol, 4-methoxy-benzoic acid, 1,3-benzodioxole-5-carbaldehyde, 4-methoxybenzyl acetate, (4-methoxyphenyl) methyl formate, methyl 2-hydroxy-4-methoxybenzoate, 4-hydroxy-benzenemethanol, 2,6-dimethoxy-phenol, 4-hydroxy-3-methoxybenzyl alcohol, 4-hydroxy-3-methoxybenzyl acetate, 4-hydroxy-3-methoxybenzyl acid, 4-(ethoxymethyl)-2-methoxyphenol, (E)-1-(4-methoxy-1-phenyl)-1-penten-3-one, 2-methyl-phenol, 1,2-dimethoxy-4-methylbenzene, vanilla extract, benzoin extract, peru balsam extract, tolu extract, guaiac wood oil, 3,4-dimethoxy-benzaldehyde, 3-ethoxy-4-hydroxybenzaldehyde, 4-(4-methoxyphenyl)-2-butanone, 3-hydroxy-2-methoxybenzaldehyde, 3-hydroxy-5-methoxybenzaldehyde, 2-Hydroxy-3-methoxybenzaldehyde, 2-Hydroxy-5-methoxybenzaldehyde, 3-hydroxy-4-methoxybenzaldehyde, 4-hydroxy-2-methoxy-benzaldehyde, 2,4-dimethoxy-benzaldehyde, 2,4-diethoxy-benzaldehyde, 2,4-dimethoxy-6-methyl-benzaldehyde, 5-ethoxy-2-hydroxy-benzaldehyde, 5-hydroxy-2-methoxy-benzaldehyde, 2,6-dimethoxy-4-methylbenzaldehyde, 2-methoxy-4-(methoxymethyl)phenol, 4-(methoxymethyl)phenol, 4-hydroxybenzaldehyde, 4-methoxy-methyl ester benzoic acid, 4-hydroxybenzoic acid, methyl 4-hydroxy-3-methoxybenzoate, ethyl 4-hydroxy-3-methoxybenzoate, 4-hydroxy-3-methoxybenzoic acid, 4-hydroxy-3,5-dimethoxy-benzaldehyde, ethyl ester 4-methoxy benzoic acid, 2-methyl-1-(p-tolyl) butane-1,3-dione, 6-(4-methoxyphenyl)-3-methylhexane-2,4-dione, lactoyl vanillin, lactoyl isovanillin, lactoyl p-hydroxybenzaldehyde, lactoyl p-hydroxy-m-methoxycinnamic acid, lactoyl isovanillin acid, oleyl vanillin, decanoyl vanillin, divanillyl succinate, lactoyl eugenol, gluconyl vanillin or any combination thereof. In some embodiments, the vanillic compound is 3-methoxy-4-hydroxybenzaldehyde, 3-ethoxy-4-hydroxybenzaldehyde, 2-hydroxy-4-methoxy-benzaldehyde, ethyl 3-methoxy-4-hydroxybenzyl ether, butyl 3-methoxy-4-hydroxybenzyl ether, or any combinations thereof. In some embodiments, the vanillic compound is 3-methoxy-4-hydroxybenzaldehyde, 3-ethoxy-4-hydroxybenzaldehyde, 2-hydroxy-4-methoxy-benzaldehyde, or any combinations thereof. In some embodiments, the vanillic compound is 3-methoxy-4-hydroxybenzaldehyde, 3-ethoxy-4-hydroxybenzaldehyde, or any combinations thereof. In some embodiments, the vanillic compound is 3-methoxy-4-hydroxybenzaldehyde, 2-hydroxy-4-methoxy-benzaldehyde, or any combinations thereof. In some embodiments, the vanillic compound is 3-methoxy-4-hydroxybenzaldehyde.

The vanillic compound can have any suitable concentration in the flavor-modifying composition. The flavor-modifying compositions disclosed herein are typically used in flavored products at concentrations ranging from 0.005 weight percent to 0.50 weight percent, or from 0.01 weight percent to 0.25 weight percent, based on the total weight of the flavored product. In some embodiments, the vanillic compounds are present in the flavored product at a concentration ranging from 0.01 ppm to 10 ppm, or from 0.05 ppm to 5 ppm, based on the total weight of the flavored product. Thus, within the flavor-modifying composition, the vanillic compound is, in certain embodiments, present at a concentration ranging from 1 ppm to 2000 ppm, or from 5 ppm to 1000 ppm, based on the total weight of the flavor-modifying composition.

In some embodiments, the flavor-modifying composition comprises a furanone compound, such as furaneol (4-hydroxy-2,5-dimethyl-3(2H) furanone), furaneol ether (4-methoxy-2,5-dimethyl-3(2H) furanone), 4-acetoxy-2,5-dimethyl-3(2H) furanone, or combinations thereof. In some embodiments, the flavor-modifying composition comprises 4-hydroxy-2,5-dimethyl-3(2H) furanone, 4-methoxy-2,5-dimethyl-3(2H) furanone, or any combination thereof. When present, the furanone compound can be present in any suitable weight ratio relative to the vanillic compound. For example, in some embodiments, the weight ratio of the vanillic compound to the furanone compound ranges from 1:10 to 10:1, or from 1:5 to 5:1, or from 1:3 to 3:1.

The furanone compound can have any suitable concentration in the flavor-modifying composition or the flavored product. In some embodiments, the furanone compounds are present in the flavored product at a concentration ranging from 0.01 ppm to 10 ppm, or from 0.05 ppm to 5 ppm, based on the total weight of the flavored product. In some embodiments, the furanone compound is, in certain embodiments, present at a concentration ranging from 1 ppm to 2000 ppm, or from 5 ppm to 1000 ppm, based on the total weight of the flavor-modifying composition.

In some embodiments, the flavor-modifying composition comprises a flavonoid or dihydrochalcone. Any suitable flavonoids or dihydrochalcones can be used. For example, in some embodiments, the flavonoid or dihydrochalcone is hesperitin dihydrochalcone, hesperitin dihydrochalcone-4′-O′glucoside, neohesperitin dihydrochalcone, naringenin, naringin, phloretin, trilobatin, eriodictyol, homoeriodictyol, brazzein, (2R,3R)-3-acetoxy-5,7,4′-trihydroxyflavanone, (2R,3R)-3-acetoxy-5,7,3′-trihydroxy-4′-methoxyflavanone, or any combination thereof. In some embodiments, the flavonoid or dihydrochalcone is hesperitin dihydrochalcone, phloretin, or any combination thereof. When present, the flavonoid or dihydrochalcone compound can be present in any suitable weight ratio relative to the vanillic compound. For example, in some embodiments, the weight ratio of the flavonoid or dihydrochalcone to the vanillic compound ranges from 1:1 to 50:1, or from 3:1 to 40:1, or from 5:1 to 30:1.

The flavonoid or dihydrochalcone can have any suitable concentration in the flavor-modifying composition or the flavored product. In some embodiments, the flavonoid or dihydrochalcone is present in the flavored product at a concentration ranging from 0.2 ppm to 200 ppm, or from 1 ppm to 100 ppm, based on the total weight of the flavored product. In some embodiments, the flavonoid or dihydrochalcone is, in certain embodiments, present at a concentration ranging from 20 ppm to 40000 ppm, or from 100 ppm to 20000 ppm, based on the total weight of the flavor-modifying composition.

In some embodiments, the flavor-modifying composition comprises a sweetener. In some embodiments, the sweetener is a non-nutritive sweetener, such as a natural non-nutritive sweetener, such as a steviol glycoside, a mogroside, a glycyrrhizic acid derivative, or any combination thereof. In some embodiments, the sweetener is a steviol glycoside, such as rebaudioside A, rebaudioside M, or any combination thereof. In some embodiments, the sweetener is a glycyrrhizic acid derivative, such as ammoniated glycyrrhizin.

In some embodiments, the flavor-modifying composition comprises a lactone. Any suitable lactone or combination of lactones can be used. In some embodiments, the lactone comprises a lactone ring having from 3 to 8 atoms in the ring, such as a 3-membered lactone ring, a 4-membered lactone ring, a 5-membered lactone ring, a 6-membered lactone ring, a 7-membered lactone ring, or an 8-membered lactone ring.

In some embodiments, the lactone comprises a 5-membered lactone ring with or without an unsaturated bond (excluding the unsaturation in the oxo substituent on the ring), such as a carbon-carbon double bond. In some embodiments, the lactone comprises a 5-membered lactone ring including at least one unsaturated bond (for example, one carbon-carbon double bond). Non-limiting examples of lactones comprising a 5-membered lactone ring having at least one unsaturated bond include angelica lactone alpha, angelica lactone beta, mint lactone, 5,5-dimethyl-2 (5H)-furanone, 5-ethyl-2 (5H)-furanone, 5-pentyl-2 (5H)-furanone, 5-hexyl-2 (5H)-furanone, 5-pentyl-2 (3H)-furanone, 4-methyl-3-pentyl-2 (5H)-furanone, and 2 (5H)-furanone. In some embodiments, the lactone comprises a 5-membered lactone ring without any unsaturated bonds. Non-limiting examples of such lactones include butyrolactone gamma, valerolactone gamma, hexalactone gamma, heptalactone gamma, octalactone gamma, undecalactone gamma, decalactone gamma, dihydrojasmone lactone, and dihydromintlactone (3,6-dimethyl-hexahydro-2 (3H)-benzofuranone). In some embodiments, the lactone is dihydromintlactone.

In some embodiments, the lactone comprises a 6-membered lactone ring with or without an unsaturated bond. In some embodiments, the lactone comprises a 6-membered lactone ring including at least one unsaturated bond. Non-limiting examples of lactones comprising a 6-membered lactone ring having at least one unsaturated bond include δ-2-decenolactone, coumarin, and 6-methylcoumarin. In some other embodiments, the lactone includes a 6-membered lactone ring without any unsaturated bonds. Non-limiting examples of lactones including a 6-membered lactone ring without any unsaturated bonds include decalactone delta, dodecalactone delta, and cyclohexyl lactone.

In some embodiments, the flavor-modifying composition comprises glucosylated natural steviol glycosides. As used herein, the term “natural steviol glycosides” refers to steviol glycosides naturally found in the plants of the species Stevia rebaudiana, Stevia phlebophylla, or Rubus chingii. Some non-limiting examples include stevioside, rebaudioside A, rebaudioside C, rebaudioside D, rebaudioside M, dulcoside A, and the like. As used herein, the term “glucosylated natural steviol glycosides” refers to compounds obtained by the enzymatic glucosylation of natural steviol glycosides to increase the degree of glucosylation. As used herein, the term “GSG” is used interchangeably with “glucosylated natural steviol glycoside.”

In embodiments in which GSGs are present, any suitable GSGs may be used. Thus, the GSGs can have any suitable degree of additional glucosylation, and any suitable type of glucosylation. In some embodiments, the GSGs used in the flavor-modifying composition have a degree of glucosylation of at least 1.0, meaning that at least one mole of glucose has been enzymatically added to the natural steviol glycosides per mole of natural steviol glycoside. In some other embodiments, the GSGs used in the flavor-modifying composition have a degree of glucosylation of at least 1.1, or at least 1.2, or at least 1.3, or at least 1.4, or at least 1.5, or at least 1.6, or at least 1.7, or at least 1.8, or at least 1.9, or at least 2.0, or at least 2.1, or at least 2.2, or at least 2.3, or at least 2.4, or at least 2.5. The glucosylation can be of any suitable type. For example, in some embodiments, the glucose enzymatically added to the natural steviol glycosides is alpha-glucose, beta-glucose, or a combination thereof. In some embodiments, the glucose enzymatically added to the natural steviol glycosides is alpha-glucose. In some embodiments, the glucose enzymatically added to the natural steviol glycosides is beta-glucose. In some embodiments, the glucose enzymatically added to the natural steviol glycosides is a combination of alpha-glucose and beta-glucose. The glucose added by enzymatic glucosylation can be incorporated via any suitable connection. Typically, the added glucose units connect to other glucose units already present on the natural steviol glycoside. In some embodiments, the enzymatically added glucose units are added via 1,6 linkages, meaning that the glucose units add via the 1-position of the added glucose unit and the 6-position of the glucose unit already present on the natural steviol glycoside. In some other embodiments, the enzymatically added glucose units are added via 1,4 linkages. In some other embodiments, the enzymatically added glucose units are added via 1,2 linkages.

In some embodiments, the flavor modifying compositions comprise a sweetener, such as a nutritive or non-nutritive sweetener.

In some embodiments, the flavor-modifying composition comprises a nutritive sugar, such as sucrose, glucose, fructose (e.g., in the form of high-fructose corn syrup), or any combination thereof. In some embodiments, the flavor-modifying composition comprises one or more rebaudiosides (such as rebaudioside A, rebaudioside D, rebaudioside E, rebaudioside M, or any combination thereof). In some embodiments, the flavor-modifying composition comprises one or more high-intensity artificial sweeteners, such as acesulfame potassium, sucralose, aspartame, cyclamate, neotame, saccharin, and the like. In some other embodiments, the flavor-modifying compositions comprise one or more low-calorie carbohydrates or sugar alcohols, such as allulose, xylitol, erythritol, and the like. In some other embodiments, the flavor-modifying compositions comprise mogrosides, for example, as monk fruit juice or extract, or as one or more of mogroside III, mogroside IV, mogroside V, siamenoside I, isomogroside V, mogroside IVE, isomogroside IVE, isomogroside IV, mogroside IIIE, 11-oxomogroside V, the 1,6-alpha isomer of siamenoside I, and any combinations thereof. Additional mogroside compounds that may be suitably included in the flavor-modifying composition are described in U.S. Pat. No. 11,357,246 and PCT Publication No. WO 2023/278226. In some embodiments, the flavor-modifying compositions comprise sweeteners such as brazzein, thaumatin, and the like.

Various other sweeteners may also be included in the flavor-modifying compositions. Non-limiting examples include D-psicose, L-ribose, D-tagatose, L-glucose, L-fucose, L-arbinose, D-turanose, D-leucrose, isomalt, lactitol, mannitol, sorbitol, maltodextrin, saccharin, alitame, cyclamic acid, tagatose, maltose, galactose, mannose, lactose, D-tryptophan, glycine, maltitol, lactitol, isomalt, hydrogenated starch hydrolyzate (HSH), chemically modified mogrosides (such as glucosylated mogrosides), carrelame and other guanidine-based sweeteners, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobatin, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

The flavor-modifying compositions can, in certain embodiments, comprise any additional ingredients or combination of ingredients as are commonly used in food and beverage products, including, but not limited to:
acids, including, for example citric acid, phosphoric acid, ascorbic acid, sodium acid sulfate, lactic acid, or tartaric acid;
bitter tastants, including, for example caffeine, quinine, green tea, catechins, polyphenols, green robusta coffee extract, green coffee extract, potassium chloride, menthol, or proteins (such as proteins and protein isolates derived from plants, algae, or fungi);
coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
clouding agents, including, for example ester gun, brominated vegetable oil (BVO), or sucrose acetate isobutyrate (SAIB);
buffers, including, for example sodium citrate, potassium citrate, or salt;
flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; or
starches and stabilizers, including, for example pectin, xanthan gum, carboxylmethylcellulose (CMC), polysorbate 60, polysorbate 80, medium chain triglycerides, cellulose gel, cellulose gum, sodium caseinate, modified food starch, gum Arabic (gum acacia), guar gum, xanthan gum, inulin, or carrageenan.

The flavor-modifying compositions can have any suitable pH when dissolved or suspended in aqueous media, e.g., from lower pH to neutral pH. The lower and neutral pH includes, but is not limited to, a pH from 1.5 to 9.0, or from 2.5 to 8.5; from 3.0 to 8.0; from 3.5 to 7.5; and from 4.0 to 7.

In some embodiments, the flavor-modifying composition comprises other suitable ingredients, such as carriers, binders, buffering agents, bulking agents, and the like.

In some embodiments, the flavor-modifying compositions comprises one or more additional flavor-modifying compounds, such as compounds that enhance sweetness, compounds that block bitterness, compounds that enhance umami, compounds that reduce sourness or licorice taste, compounds that enhance saltiness, compounds that enhance a cooling effect, or any combinations of the foregoing.

Thus, in some embodiments, flavor-modifying compositions disclosed herein comprise one or more sweetness enhancing compounds. Such sweetness enhancing compounds include, but are not limited to, 3-((4-amino-2,2-dioxo-1H-benzo[c][1,2,6]thiadiazin-5-yl)oxy)-2,2-dimethyl-N-propyl-propanamide, N-(1-((4-amino-2,2-dioxo-1H-benzo[c][1,2,6]thiadiazin-5-yl)oxy)-2-methyl-propan-2-yl)isonicotinamide, 4-amino-5,6-dimethylthieno[2,3-d]pyrimidin-2 (1H)-one, hesperitin dihydrochalcone, hesperitin dihydrochalcone-4′-O′glucoside, neohesperitin dihydrochalcone, naringenin, naringin, phloretin, glucosylated steviol glycosides, trilobatin, eriodictyol, homoeriodictyol, brazzein, (2R,3R)-3-acetoxy-5,7,4′-trihydroxyflavanone, (2R,3R)-3-acetoxy-5,7,3′-trihydroxy-4′-methoxyflavanone, rubusosides, or compounds such as those set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032.

In some embodiments, the flavor-modifying composition comprises phloretin, hesperitin dihydrochalcone, or any combination thereof. In some embodiments, the flavor-modifying composition comprises glucosylated steviol glycosides. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth.

In some further embodiments, flavor-modifying compositions disclosed herein comprise one or more umami or kokumi enhancing compounds. Such umami enhancing compounds include, but are not limited to, naturally derived compounds, such as (E)-3-(3,4-dimethoxyphenyl)-N-(4-methoxyphenethyl)-acrylamide, or synthetic compounds, such as N-(heptan-4-yl)-benzo[d][1,3]dioxole-5-carboxamide, N1-(2,4-dimethoxybenzyl)-N2-(2-(pyridin-2-yl)ethyl)-oxalamide, alkyl amides, or any other compounds set forth in U.S. Pat. Nos. 8,735,081; 8, 124,121; and 8,968,708.

In some further embodiments, flavor-modifying compositions disclosed herein comprise one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727. In some embodiments, the comestible composition comprises: N-ethyl-N-(thiophen-2-ylmethyl)-2-(p-tolyloxy)acetamide; N-(1H-pyrazol-3-yl)-N-(thiophen-2-ylmethyl)-2-(p-tolyloxy)acetamide; 2-(4-fluorophenoxy)-N-(1H-pyrazol-3-yl)-N-(thiophen-2-ylmethyl)acetamide; 2-(2-hydroxy-4-methylphenoxy)-N-(1H-pyrazol-3-yl)-N-(thiophen-2-ylmethyl)-acetamide; 2-((2,3-dihydro-1H-inden-5-yl)oxy)-N-(1H-pyrazol-3-yl)-N-(thiophen-2-ylmethyl)-acetamide; 2-((2,3-dihydro-1H-inden-5-yl)oxy)-N-(1H-pyrazol-3-yl)-N-(thiazol-5-ylmethyl)-acetamide; 2-((5-methoxybenzofuran-2-yl)oxy)-N-(1H-pyrazol-3-yl)-N-(thiophen-2-ylmethyl)-acetamide, or any combination thereof in any of the aforementioned ratios. In some embodiments, such flavor-modifying compositions comprise menthol or a menthol analogue. In some further embodiments, such flavor-modifying compositions are compositions for use in oral care products, such as toothpaste, mouthwash, whitening compositions, dentifrices, and the like.

In some further embodiments, flavor-modifying compositions disclosed herein comprise one or more other bitterness blocking compounds. Such bitterness blocking compounds include, but are not limited to 3-(1-((3,5-dimethylisoxazol-4-yl)methyl)-1H-pyrazol-4-yl)-1-(3-hydroxybenzyl)-imidazolidine-2,4-dione, N-(7-acetyl-2,3-dihydrobenzo-[b][1,4]dioxin-6-yl)-2-(4-acetylpiperazin-1-yl)acetamide, or other compounds set forth in U.S. Pat. Nos. 8,076,491; 8,445,692; and 9,247,759, or in PCT Publication No. WO 2020/033669.

In some further embodiments, flavor-modifying compositions disclosed herein comprise one or more sour taste modulating compounds, such as low-molecular-weight organic acids, such as acetic acid, lactic acid, malic acid, citric acid, ascorbic acid, and malonic acid.

In some further embodiments, flavor-modifying compositions disclosed herein comprise one or more mouthfeel modifying compounds. Such mouthfeel modifying compounds include, but are not limited to, tannins, cellulosic materials, bamboo powder, and the like.

The flavor-modifying composition can be in any suitable form. For example, in some embodiments, the composition is in the form of a solid, such as a solid powder. In some such embodiments, the composition also comprises a solid carrier, such as a carbohydrate. In some other embodiments, the flavor-modifying composition is in the form of a liquid solution or suspension. Such a liquid form can be aqueous or non-aqueous, or can also be an emulsion, such as an oil-in-water or water-in-oil emulsion. In some embodiments, the flavor-modifying composition is incorporated into a flavored product, such as a food or beverage product, or an oral care product, such as a toothpaste or mouthwash.

In some embodiments, the flavor-modifying composition comprises one or more flavorings, or any other additives described in H. Mitchell, SWEETENERS AND SUGAR ALTERNATIVES IN FOOD TECHNOLOGY, Blackwell Publishing Ltd, 2006. As used herein, the term “flavorings” includes those flavors known to the skilled person, such as natural and artificial flavors. These flavorings may be chosen from synthetic flavor oils and flavoring aromatics or oils, oleoresins and extracts derived from plants, leaves, flowers, fruits, and so forth, and combinations thereof. Non-limiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Other useful flavorings are artificial, natural and synthetic fruit flavors such as vanilla, and citrus oils including lemon, orange, lime, grapefruit, yuzu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with cooling agents.

Flavors may also provide breath freshening properties, particularly the mint flavors when used in combination with cooling agents. These flavorings may be used in liquid or solid form and may be used individually or in admixture. Other useful flavorings include aldehydes and esters such as cinnamyl acetate, cinnamaldehyde, citral diethylacetal, dihydrocarvyl acetate, eugenyl formate, p-methylamisol, and so forth may be used. Generally, any flavoring or food additive such as those described in CHEMICALS USED IN FOOD PROCESSING, publication 1274, pages 63-258, by the National Academy of Sciences, may be used.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof. These listings of flavorings are merely exemplary and are not meant to limit either the term “flavoring” or the scope of the disclosure generally.

### Uses, Methods, and Flavored Products

In certain aspects, the disclosure provides uses of the flavor-modifying composition of the preceding aspect, and any embodiments thereof, to reduce an off note of a flavored product. In some embodiments, the off note is a bitter taste, an astringent taste, a metallic taste, a sour taste, a salty taste, a burning taste, an aldehydic taste, or any combination thereof. In some embodiments, the use comprises reducing a bitter taste. In some embodiments, the use comprises reducing an astringent taste. In some embodiments, the use comprises reducing a metallic taste. In some embodiments, the use comprises reducing a sour taste. In some embodiments, the use comprises reducing a salty taste. In some embodiments, the use comprises reducing a burning taste. In some embodiments, the use comprises reducing an aldehydic taste.

In certain aspects, the disclosure provides methods for reducing an off note of a flavored product, the method comprising introducing a flavor-modifying composition of the preceding aspect, or any embodiments thereof, to the flavored product. In some embodiments, the off note is a bitter taste, an astringent taste, a metallic taste, a sour taste, a salty taste, a burning taste, an aldehydic taste, or any combination thereof. In some embodiments, the method comprises reducing a bitter taste. In some embodiments, the method comprises reducing an astringent taste. In some embodiments, the method comprises reducing a metallic taste. In some embodiments, the method comprises reducing a sour taste. In some embodiments, the method comprises reducing a salty taste. In some embodiments, the method comprises reducing a burning taste. In some embodiments, the method comprises reducing an aldehydic taste.

In certain aspects and in certain embodiments of the preceding aspects, the disclosure provides flavored products comprising a flavor-modifying composition of the preceding aspect and a health-promoting ingredient, such as a vitamin compound, a mineral compound, an antioxidant, an amino acid, a fatty acid or fatty acid ester, an electrolyte, or any combination thereof. In some embodiments, the health-promoting ingredient has an off note. In some embodiments, the off note is a bitter taste, an astringent taste, a metallic taste, a sour taste, a salty taste, a burning taste, an aldehydic taste, or any combination thereof.

In connection with these aspects, the flavored product can be any flavored product according to the aspects and embodiments set forth below. In some embodiments, the flavored product is a beverage product, such as enhanced sparkling beverages, colas, lemon-lime flavored sparkling beverages, orange flavored sparkling beverages, grape flavored sparkling beverages, strawberry flavored sparkling beverages, pineapple flavored sparkling beverages, ginger-ales, root beers, fruit juices, fruit-flavored juices, juice drinks, nectars, vegetable juices, vegetable-flavored juices, sports drinks, energy drinks, enhanced water drinks, enhanced water with vitamins, near water drinks, coconut waters, tea type drinks, coffees, cocoa drinks, beverages containing milk components, and beverages containing cereal extracts and smoothies. In some other embodiments, the flavored product is a food product, such as a packaged meals, canned foods, meal replacement bar, and the like. In some embodiments, the flavored product is an oral care product, such as a toothpaste, a mouthwash, or a teeth-whitening composition, such as a composition disclosed in U.S. Patent Application Pub. No. 2019/0167545.

As noted above, the flavored product comprises one or more health-promoting ingredients. In some embodiments, the health-promoting ingredient comprises a mineral compound. Non-limiting examples of such compounds include: metal salts or covalent metal compounds (e.g., metal oxides), such as salts or covalent compounds of calcium, iron, magnesium, potassium, sodium, zinc, chromium, copper, molybdenum, manganese, and selenium; iodine; chlorides; fluorides; phosphorus-containing compounds; and any combinations thereof.

In some embodiments, the health-promoting ingredient comprises one or more vitamins. Some non-limiting examples of vitamins include vitamin A, thiamine, riboflavin, niacin, pantothenic acid, biotin, vitamin B6, vitamin B12, folate, vitamin C, vitamin D, vitamin E, vitamin K, and any combination thereof.

In some embodiments, the health-promoting ingredient comprises one or more antioxidants. Some non-limiting examples of antioxidants include ascorbic acid, calcium disodium EDTA, alpha tocopherols, mixed tocopherols, rosemary extract, grape seed extract, resveratrol, sodium hexametaphosphate, flavonoids, glutathione, anthocyanins, polyphenols, astaxanthin, carotenoids, coenzyme Q10, quercetin, lutein, tea extracts, fruit extracts, vegetable extracts, root extracts (such as ginger extract or gensing extract), and any combination thereof.

In some embodiments, the health-promoting ingredient comprises one or more amino acids. Non-limiting examples of such amino acids include histidine, isoleucine, leucine, lysine, methionine, phenylalanine, taurine, threonine, tryptophan, valine, arginine, cysteine, glutamine, glycine, proline, tyrosine, alanine, aspartic acid, asparagine, glutamic acid, serine, selenocysteine, pyrrolysine, and any combinations thereof.

In some embodiments, the health-promoting ingredient comprises one or more fatty acids or fatty acid esters (e.g., fatty acid glycerides). Some non-limiting examples include free acids and esters of decanoic acid, dodecanoic acid, alpha-linolenic acid, eicosapentaenoic acid, docosahexaenoic acid, and any combination thereof.

In some embodiments, the health-promoting ingredient comprises one or more electrolytes. Some non-limiting examples include fluorides and chlorides of sodium, potassium, magnesium, calcium, and any combinations thereof.

In embodiments where the flavored product is a beverage. The beverage may be selected from the group consisting of enhanced sparkling beverages, colas, lemon-lime flavored sparkling beverages, orange flavored sparkling beverages, grape flavored sparkling beverages, strawberry flavored sparkling beverages, pineapple flavored sparkling beverages, ginger-ales, root beers, fruit juices, fruit-flavored juices, juice drinks, nectars, vegetable juices, vegetable-flavored juices, sports drinks, energy drinks, enhanced water drinks, enhanced water with vitamins, near water drinks, coconut waters, tea type drinks, coffees, cocoa drinks, beverages containing milk components, beverages containing cereal extracts and smoothies. In some embodiments, the beverage may be a soft drink.

In some embodiments, the flavored product is an oral care product. By “oral care product” is meant a personal care product or other product, which in the ordinary course of usage, is not intentionally swallowed for purposes of systemic administration of particular therapeutic agents, but is rather retained in the oral cavity for a time sufficient to contact substantially all of the dental surfaces and/or oral tissues for purposes of oral activity. The oral care composition may be in various forms including toothpaste, dentifrice, tooth gel, subgingival gel, mouthrinse, mousse, foam, mouthspray, lozenge, chewable tablet, chewing gum or denture product. The oral care composition may also be incorporated onto strips or films for direct application or attachment to oral surfaces.

In some embodiments, the flavored product is a pharmaceutical product, such as a product designed to carry or deliver certain active pharmaceutical ingredients (APIs). Such APIs can be over-the-counter (OTC) drugs, such as acetaminophen and other OTC cough and cold medications. In some embodiments, the API is a prescription-based drug.

In certain embodiments of any aspects and embodiments set forth herein that refer to a flavored product, the flavored product is a non-naturally-occurring product, such as a packaged food or beverage product.

The beverage category usually means beverages, beverage mixes and concentrates, including but not limited to, carbonated and non-carbonated beverages, alcoholic and non-alcoholic beverages, ready to drink beverages, liquid concentrate formulations for preparing beverages such as sodas, and dry powdered beverage precursor mixes. The Beverage category also includes the alcoholic drinks, the soft drinks, sports drinks, isotonic beverages, and hot drinks. The alcoholic drinks include, but are not limited to beer, cider/perry, flavored alcoholic beverages (FABs), wine, and spirits. The soft drinks include, but are not limited to carbonates, such as colas and non-cola carbonates; fruit juice, such as juice, nectars, juice drinks and fruit flavored drinks; bottled water, which includes sparkling water, spring water and purified/table water; functional drinks, which can be carbonated or still and include sport, energy or elixir drinks; concentrates, such as liquid and powder concentrates in ready to drink measure. The drinks, either hot or cold, include, but are not limited to coffee or ice coffee, such as fresh, instant, and combined coffee; tea or ice tea, such as black, green, white, oolong, and flavored tea; and other drinks including flavor-, malt- or plant-based powders, granules, blocks or tablets mixed with milk or water.

In some embodiments, the flavor-modifying compositions as disclosed and described herein, individually or in combination, may be provided in a flavoring concentrate formulation, e.g., suitable for subsequent processing to produce a ready-to-use (i.e., ready-to-serve) product. By “a flavoring concentrate formulation”, it is meant a formulation which should be reconstituted with one or more diluting medium to become a ready-to-use composition. The term “ready-to-use composition” is used herein interchangeably with “ingestible composition”, which denotes any substance that, either alone or together with another substance, can be taken by mouth whether intended for consumption or not. In one embodiment, the ready-to-use composition includes a composition that can be directly consumed by a human or animal. The flavoring concentrate formulation is typically used by mixing with or diluted by one or more diluting medium, e.g., any consumable or ingestible ingredient or product, to impart or modify one or more flavors to the diluting medium. Such a use process is often referred to as reconstitution. The reconstitution can be conducted in a household setting or an industrial setting. For example, a frozen fruit juice concentrate can be reconstituted with water or other aqueous medium by a consumer in a kitchen to obtain the ready-to-use fruit juice beverage. In another example, a soft drink syrup concentrate can be reconstituted with water or other aqueous medium by a manufacturer in large industrial scales to produce the ready-to-use soft drinks. Since the flavoring concentrate formulation has the flavoring agent or flavor modifying agent in a concentration higher than the ready-to-use composition, the flavoring concentrate formulation is typically not suitable for being consumed directly without reconstitution. There are many benefits of using and producing a flavoring concentrate formulation. For example, one benefit is the reduction in weight and volume for transportation as the flavoring concentrate formulation can be reconstituted at the time of usage by the addition of suitable solvent, solid or liquid.

In one embodiment, the flavoring concentrate formulation comprises i) compounds as disclosed and described herein, individually or in combination; ii) a carrier; and iii) optionally at least one adjuvant. The term “carrier” denotes a usually inactive accessory substance, such as solvents, binders, or other inert medium, which is used in combination with the present compound and one or more optional adjuvants to form the formulation. For example, water or starch can be a carrier for a flavoring concentrate formulation. In some embodiments, the carrier is the same as the diluting medium for reconstituting the flavoring concentrate formulation; and in other embodiments, the carrier is different from the diluting medium. The term “carrier” as used herein includes, but is not limited to, ingestibly acceptable carrier.

The term “adjuvant” denotes an additive which supplements, stabilizes, maintains, or enhances the intended function or effectiveness of the active ingredient, such as the compound of the present invention. In one embodiment, the at least one adjuvant comprises one or more flavoring agents. The flavoring agent may be of any flavor known to one skilled in the art or consumers, such as the flavor of chocolate, coffee, tea, mocha, French vanilla, peanut butter, chai, or combinations thereof. In another embodiment, the at least one adjuvant comprises one or more sweeteners. The one or more sweeteners can be any of the sweeteners described in this application. In another embodiment, the at least one adjuvant comprises one or more ingredients selected from the group consisting of an emulsifier, a stabilizer, an antimicrobial preservative, an antioxidant, vitamins, minerals, fats, starches, protein concentrates and isolates, salts, and combinations thereof. Examples of emulsifiers, stabilizers, antimicrobial preservatives, antioxidants, vitamins, minerals, fats, starches, protein concentrates and isolates, and salts are described in U.S. Pat. No. 6,468,576, the content of which is hereby incorporated by reference in its entirety for all purposes.

In one embodiment, the present flavoring concentrate formulation can be in a form selected from the group consisting of liquid including solution and suspension, solid, foamy material, paste, gel, cream, and a combination thereof, such as a liquid containing certain amount of solid contents. In one embodiment, the flavoring concentrate formulation is in form of a liquid including aqueous-based and nonaqueous-based. In some embodiments, the present flavoring concentrate formulation can be carbonated or non-carbonated.

The flavoring concentrate formulation may further comprise a freezing point depressant, nucleating agent, or both as the at least one adjuvant. The freezing point depressant is an ingestibly acceptable compound or agent which can depress the freezing point of a liquid or solvent to which the compound or agent is added. That is, a liquid or solution containing the freezing point depressant has a lower freezing point than the liquid or solvent without the freezing point depressant. In addition to depress the onset freezing point, the freezing point depressant may also lower the water activity of the flavoring concentrate formulation. The examples of the freezing point depressant include, but are not limited to, carbohydrates, oils, ethyl alcohol, polyol, e.g., glycerol, and combinations thereof. The nucleating agent denotes an ingestibly acceptable compound or agent which is able to facilitate nucleation. The presence of nucleating agent in the flavoring concentrate formulation can improve the mouthfeel of the frozen Blushes of a frozen slush and to help maintain the physical properties and performance of the slush at freezing temperatures by increasing the number of desirable ice crystallization centers. Examples of nucleating agents include, but are not limited to, calcium silicate, calcium carbonate, titanium dioxide, and combinations thereof.

In one embodiment, the flavoring concentrate formulation is formulated to have a low water activity for extended shelf life. Water activity is the ratio of the vapor pressure of water in a formulation to the vapor pressure of pure water at the same temperature. In one embodiment, the flavoring concentrate formulation has a water activity of less than about 0.85. In another embodiment, the flavoring concentrate formulation has a water activity of less than about 0.80. In another embodiment, the flavoring concentrate formulation has a water activity of less than about 0.75.

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described and claimed herein. The reader will recognize that the skilled artisan, armed with the present disclosure, and skill in the art is able to prepare and use the invention without exhaustive examples.

### Example 1—Sample Energy Drink

An energy drink was formulated according to certain embodiments of the present disclosure. Table 1 below sets forth a list of ingredients for inclusion in the energy drink, as well as their recommended weight (in grams) when incorporated into an energy drink.

TABLE 1

| Ingredient | Wt (g) |
|---|---|
| Energy basic premix¹ | 1.00 |
| Eye health premix² | 0.28 |
| Muscle function premix³ | 1.98 |
| Natural masking flavor⁴ | 0.35 |
| Mineral masking composition⁵ | 0.18 |
| TastePRINT SW (Firmenich, Satigny, Switzerland)⁶ | 0.21 |
| Natural ginger flavor | 0.44 |
| Sucrose | 20.9 |
| Citric acid | 1.2 |
| Carbonated water | up to 330 |

¹Blend including vitamin B3, vitamin B5, vitamin B6, vitamin B12, caffeine, and taurine.
²Blend including lutein, zinc, and vitamin A.
³Blend including potassium, magnesium, calcium, and vitamin D3.
⁴Blend including maltol, thaumatin, furaneol, and ammoniated glycyrrhizin.
⁵Blend including vanillin, furaneol, furaneol methyl ether, phloretin, and maltol.
⁶Blend including rebaudioside A, rebaudioside B, and rebaudioside M.

1. A flavor-modifying composition, which comprises: (a) a vanillic flavor compound;
(b) optionally, a furanone compound; (c) optionally, a flavonoid, a dihydrochalcone, or a combination thereof; and (d) optionally, a sweetener.

2. The flavor-modifying composition of claim 1, which further comprises one or more of:
(b) a furanone compound; (c) a flavonoid, a dihydrochalcone, or a combination thereof; and (d) a sweetener.

3. The flavor-modifying composition of claim 1, wherein the vanillic flavor compound is
3-methoxy-4-hydroxybenzaldehyde, 3-ethoxy-4-hydroxybenzaldehyde, 2-hydroxy-4-methoxy-benzaldehyde, or any combinations thereof.

4. The flavor-modifying composition of claim 1, wherein the furanone compound is 4-hydroxy-2,5-dimethyl-3(2H)-furanone, 4-methoxy-2,5-dimethyl-3(2H)-furanone, 4-acetoxy-2,5-dimethyl-3(2H)-furanone, or combinations thereof.

5. The flavor-modifying composition of claim 1, wherein the flavonoid, dihydrochalcone, or combination thereof is phloretin, hesperitin dihydrochalcone, or any combination thereof.

6. The flavor-modifying composition of claim 1, wherein the sweetener is a steviol glycoside, a mogroside, a glycyrrhizic acid derivative, or any combination thereof.

7. (canceled)

8. (canceled)

9. (canceled)

10. A method of reducing an off note of a flavored product, the method comprising introducing the flavor-modifying composition of claim 1 to the flavored product, wherein the flavored product comprises one or more minerals, one or more vitamins, or any combination thereof, and wherein the off note results from the one or more minerals, the one or more vitamins, or any combination thereof.

11. The method of claim 10, wherein reducing an off note comprises reducing a bitter taste, reducing an astringent taste, reducing a metallic taste, reducing a salty taste, reducing a sour taste, reducing a burning taste, reducing aldehydic taste, or any combination thereof.

12. The method of claim 10, wherein the flavored product is a beverage.

13. A flavored product, which comprises a flavor-modifying composition of claim 1 and one or more minerals, one or more vitamins, or any combination thereof.

14. The flavored product of claim 13, which is a beverage product.
